(19) United States
(12) Patent Application Publication
(10) Pub. No.: US 2008/0250068 A1
(43) Pub. Date: Oct. 9, 2008

(54) SYSTEM FOR PREPARING REPORTS

(75) Inventors: SIMON JOHN MARTYN, READING (GB); BEN NORRIS, LONDON (GB)

Correspondence Address: CANTOR COLBURN, LLP, 20 Church Street, 22nd Floor, Hartford, CT, 06103, US

(73) Assignee: EXCEL WIZARDS LTD., READING (GB)

(21) Appl. No.: 11/758,212

(22) Filed: Jun. 5, 2007

(30) Foreign Application Priority Data
Mar. 14, 2007 (GB) 0704929.9

(51) Int. Cl. G06F 15/04; G06F 17/30

(52) U.S. Cl. 707/104.1; 707/E17.054; 707/100; 707/E17.046

(57) ABSTRACT

A method of preparing customised reports from source data comprises:
retrieving a report definition from a first database;
   loading the retrieved report definition into a report-generating means, wherein the report-generating means is independent of said first database;
retrieving source data from a second database into said report-generating means as specified by said report definition; and
performing operations on said retrieved source data to produce a report in accordance with the report definition.

### TECHNICAL FIELD OF INVENTION

This invention relates to a system and method for using definitions to prepare customised reports from data stored in a database.

### BRIEF DISCUSSION OF RELATED ART

It is often desirable to construct reports that selectively represent or summarise information from a database. The same style or layout of report may be appropriate in more than one situation, even if the data are different. For example, a financial summary for a company may present the same data types, such as annual turnover, in the same layout year after year, but with different values each year. The source data may need to be manipulated during the creation of a report, and it is therefore often desirable to employ a computer when producing reports. In order to expedite the production of similar reports, it is known to use a definition as the basis for a report, with the computer retrieving and processing data as necessary to produce a report according to the definition.

When data are stored in multidimensional databases, it is often possible only to view a portion of the data at a time, essentially a two-dimensional projection. For a high-dimension database, many different two-dimensional projections are possible thus giving rise to a large number of possible reports, each of which can only give a limited view.

It is known to provide an Excel® spreadsheet add-in file which builds a report using report definitions stored as additional pages within the spreadsheet file for generating reports from a multi-dimensional financial database. However this requires formulae to be entered into cells of the spreadsheet with special knowledge of the codes for extracting data from the various dimensions of the database. It also means that the reports are very difficult to produce and later modify or de-bug. Furthermore the reports produced in this way are static—a user viewing the report can only view the data that the report author has chosen to display.

It is an aim of the present invention to improve the generation of reports.

### BRIEF SUMMARY OF THE INVENTION

When viewed from a first aspect the invention provides a method of preparing customised reports from source data comprising:
retrieving a report definition from a first database;
loading the retrieved report definition into a report-generating means, wherein the report-generating means is independent of said first database;
retrieving source data from a second database into said report-generating means as specified by said report definition; and
performing operations on said retrieved source data to produce a report in accordance with the report definition.

The invention extends to apparatus for preparing customised reports from source data comprising:

a first database containing a plurality of report definitions;

a report-generating means independent of said first database; and

a second database comprising source data,

wherein said apparatus is arranged to:

retrieve a report definition from said first database;

retrieve source data from said second database; and

perform operations on said retrieved source data to produce a report in accordance with said report definition.

Thus it will be seen by those skilled in the art that in accordance with the invention report definitions are stored in a database separately from the report-generating means and from data which are used to generate reports from them. Storing the report definitions separately from the data which will be used to generate reports from them facilitates implementation of the system as an enhancement to an existing package without having to integrate the two. Furthermore by storing the report definitions themselves in a database separate from the report-generating means the definitions can be more easily managed, indexed and accessed than would otherwise be the case. The invention is therefore of particular benefit where a relatively large number of possible reports is available for a given set of source data. It is also of particular benefit in multi-user environments since the database can act as a central repository resource for the definitions allowing multiple simultaneous access, and allowing modifications or updates to any of the report definitions by any user to be quickly shared amongst other users.

A further benefit realised in accordance with the invention is that the organisation and administration of the report definitions is not restricted by the functionality of the report-generating means. For example the report definitions may be arranged to import data in other formats such as graph definitions, images etc. which can also be stored in the first database. This makes the extraction of the information required to generate a report simpler because the report-generating means only needs to access one data source, namely the first database, to build the report.

In preferred embodiments the first database comprises information relating to the hierarchy of the data structures of the second database. Storing such metadata in the first database allows a user to ‘drill down’ from parent data in the report to see the underlying child data, but without having to impair performance, especially over a network, by making metadata queries of the second database. It also means that the metadata can be stored in a format which is optimised for generating a particular report. It will be appreciated that the dual database structure provided in accordance with the invention allows these advantages to be realised.

The first database storing the report definitions could be of any convenient type but in preferred embodiments it comprises a relational database. The Applicant has appreciated that the relational database structure is best suited to storing report definitions and elements thereof. The dual database structure of the invention clearly permits such optimisation.

Preferably the report definitions are stored in the first database as binary objects, most preferably Binary Long Objects (BLOBs). They might contain some or all of row headers, column headers, the report title, formatting information, what commentary is to be added to the report, and what charts are used in the report.

In presently preferred embodiments the report-generating means is a spreadsheet application and the report definitions comprise spreadsheet files. In a preferred method the report definitions are stored in the first database by copying a portion of a spreadsheet representing a report definition into a temporary spreadsheet, converting said spreadsheet into a binary object, preferably a binary long object, and storing said binary long object as an object in said first database. Preferably said binary object is stored in said first database as an Object Linking and Embedding (OLE) object.

In preferred embodiments the report-generating means comprises a spreadsheet containing Visual Basic code. The term ‘spreadsheet’ is intended to indicate a general class of file types which can be read by spreadsheet applications such as Microsoft Excel® and does not imply any particular detailed structure. Most preferably the spreadsheet comprises an Addin, well known per se in the art.

Examples of operations which might be carried out on the source data in accordance with the report definition include, but are not limited to, inserting it into predetermined cells, adding, subtracting, multiplying, dividing, copying or performing other calculations on the data, expanding a header item to its child members

The report definition might include things such as, grouping a collection of rows/columns together, hiding rows/columns, deleting the contents or rows/columns, adding graphs to the report, formatting cells for appearance (e.g. shading borders, font size, colours, number format).

Although functionally independent of one another the first database and report-generating means could be provided on a common server. Preferably however, the first database is hosted on a different server from the report-generating process. In some preferred embodiments the second database is hosted on a different server from the report-generating process. The first and second databases may or may not be hosted on the same server as each other.

Preferably the second database is a multidimensional database. In preferred embodiments the source data stored in the second database comprises financial data, e.g. from a number of financial ledgers. In one set of embodiments for example the second database comprises a financial consolidation package. It should be appreciated however that the nature of the data is not essential to the invention.

Preferably the report-generating means is arranged to create a blank spreadsheet, retrieve a report definition spreadsheet from the first database and copy data from the report definition spreadsheet to said blank spreadsheet.

Preferably the report-generating means is adapted to allow the creation of a new report definition and/or the modification of an existing definition. This therefore gives the facility to customise definitions. The storage of the definitions in a database allows this generation of new or modified definitions easily to be managed, shared and audited. Such functionality might be reserved to authorised users.

In some preferred implementations of the invention the first and second databases are linked to enable sharing of user authentication. For example access to the report definitions on the first database is only permitted once a user has been authenticated by the second database. This is efficient since it recognises that the second database containing financial information will have authentication procedures and so avoids the need to have to provide a separate procedure for the first database.

When viewed from a further aspect the invention provides computing apparatus having means for generating a report, said report-generating means being arranged to communicate with a first database server having a database containing report definitions to retrieve a report definition therefrom; and also being arranged to communicate with a second database containing source data for retrieving said source data therefrom, the report-generating means further being arranged to perform operations on said retrieved source data to produce a report in accordance with the report definition.

When viewed from another aspect the invention provides a relational database comprising a plurality of binary objects corresponding to report definitions for a spreadsheet application.

When viewed from a further aspect the invention provides a computer software product which when run on computing means causes it to:

retrieve a report definition from a first database;

load the retrieved report definition into a report-generating means, wherein the report-generating means is independent of said first database;

retrieve source data from a second database into said report-generating means as specified by said report definition; and

perform operations on said retrieved source data to produce a report in accordance with the report definition.

When viewed from a further aspect the invention provides software and/or a software product for generating a report comprising:

logic for retrieving a report definition from a first independent database, said report definition a source data specification;

logic for retrieving source data from a second independent database as specified in said source data specification; and

logic for performing operations on said source data to produce a report in accordance with said report definition.

The invention further extends to a data carrier carrying software as set out hereinabove. Here the term data carrier is intended to mean any computer-readable medium by which data can be carried, including, but not limited to: floppy or hard disks, optical disks, solid state memory, flash memory and electromagnetic signals.

### BRIEF DESCRIPTION OF DRAWINGS

A preferred embodiment of the present invention will now be described, by way of example only, with reference to the accompanying drawings, in which:

FIG. 1 is a schematic diagram of a system in accordance with the invention;

FIG. 2 is a diagram showing steps taken when first starting the system;

FIG. 3 is a diagram showing steps taken when creating a new definition;

FIG. 4 is a diagram showing steps taken when creating a report; and

FIG. 5 is a diagram showing steps taken when adding a graph or commentary to a definition.

### DETAILED DESCRIPTION OF EMBODIMENTS

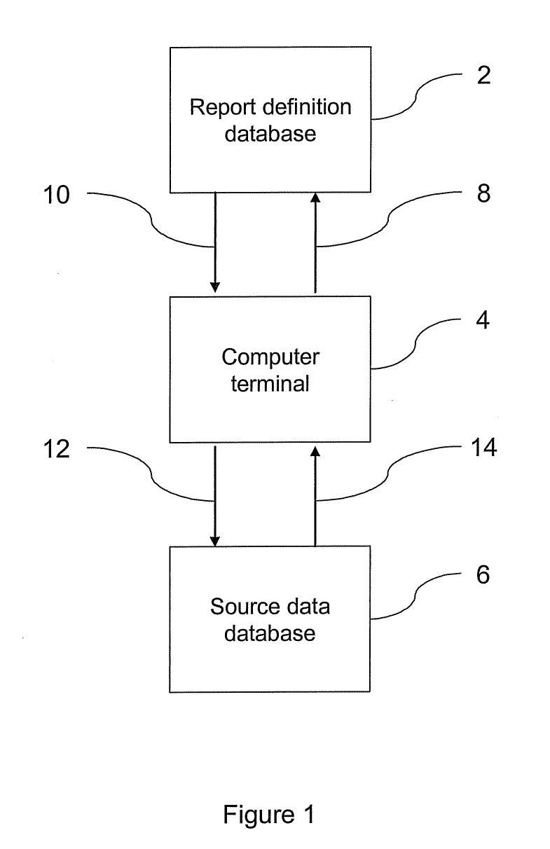

FIG. 1 is a schematic diagram of the major elements of the system as a whole. It comprises: a server running a report definition relational database 2 implemented using Microsoft Access®, a computer terminal 4, e.g. a PC; and further server running a multi-dimensional source data database 6 created using Hyperion Financial Management® software. There are two way communication connections 8,10,12,14 between each of the two servers 2, 6 respectively and the computer terminal 4.

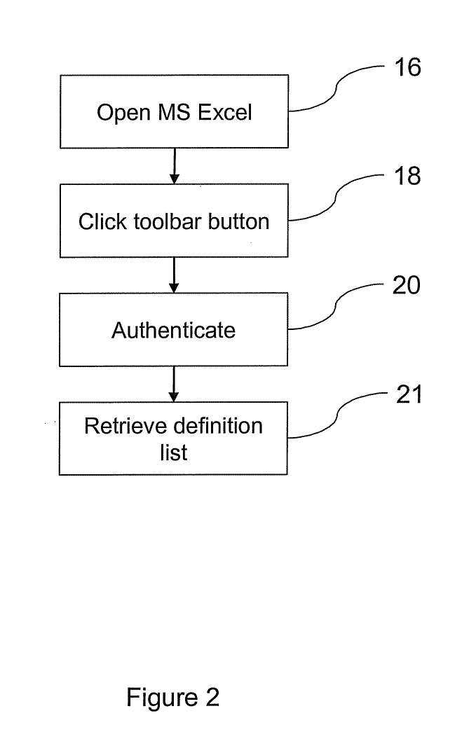

FIG. 2 shows the control flow executed when a session starts. The user starts 16 the Microsoft Excel® application on the computer terminal. Earlier installation of the report-generating system has resulted in certain enhancements being automatically available within Excel. Among these is a custom toolbar for report-generating functions. The user clicks 18 a button on this toolbar, which causes a report-generating spreadsheet to load. The Visual Basic® code embedded in this spreadsheet causes the computer terminal to connect and authenticate 20 the user first to the source data database 6 and secondly to the report definition database 2. It then retrieves 21 a list of previously-created report definitions from the definition database. Powerful searching functions provided by the Access database may be used to select the appropriate report definition or subset from which to choose.

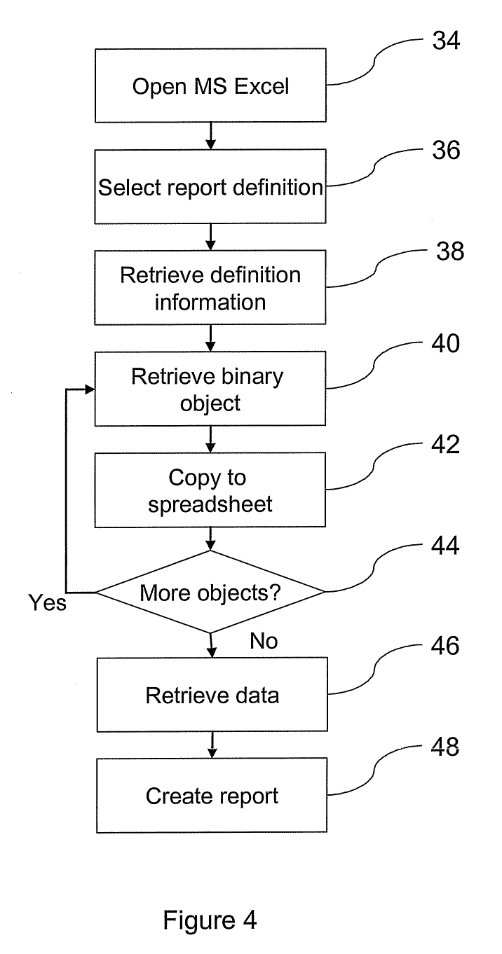

Turning to FIG. 4, the user then selects 36 a report definition. More detailed report definition information, including subcomponent elements, is retrieved 38 from the report definition database. The computer terminal then retrieves 40 a first element from the report definition database, in the form of a binary object, which it converts and copies 42 to a temporary spreadsheet. This may be the row and column headers for the report, or may be a graph or text box. If it determines 44 that further elements are required, it retrieves 40 the next one, and so on until all required elements have been retrieved.

The computer terminal 4 then interprets the row and column headers to build a data query which it passes to the source data database in order to retrieve 46 the necessary source data. It then uses the retrieved report definition elements and source data to perform operations on the source data defined in the report definition to create 48 the report.

The report-generating software examines every cell on the report template and builds a data query which is passes to the second database. When the data is returned it examines each cell and inserts the appropriate data element. It places the data in cells at the intersection of the row and column headers that index the data item. It performs calculations on the source data in a manner prescribed in the report definition.

The report generation process examines each row and column header in the report template to determine the appropriate format (shading, borders, font size, font colour, number format etc) of the intersecting cell in the data area of the report.

When examining each row and column of the report the report-generating program will perform functions such as expand the header item to its child members, group a collection of rows/columns together, hide the rows/columns delete the contents of the row/column, or add graphs to the report.

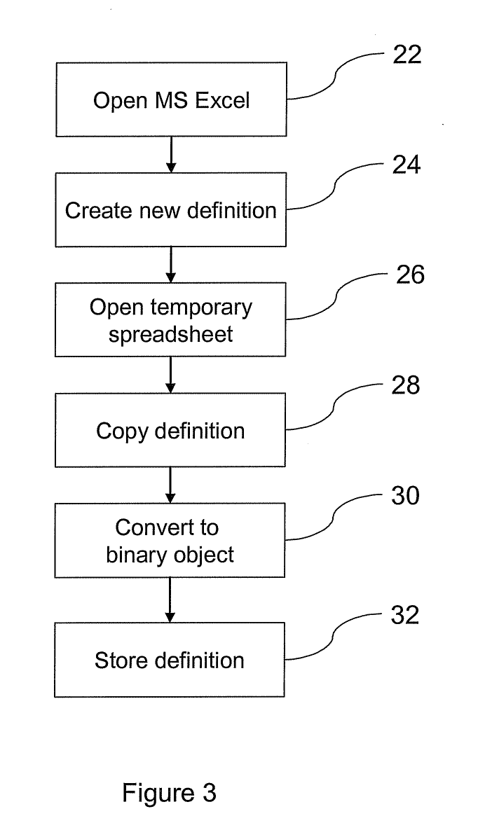

FIG. 3 shows the control flow executed when creating a new report definition. After the spreadsheet programme, including report-generating enhancements, is started 22, the user creates 24 the new definition within a blank spreadsheet. This may include row and column dimension definitions, formatting, formulae, references, description and notes. Once this is done, Visual Basic code instructs the computer terminal to open 26 a second, blank spreadsheet into which it copies 28 the relevant portions of the newly-created report definition sheet. The temporary second sheet is converted 30 into a binary long object which is stored 32 as a new OLE object entry in the report definition database 2

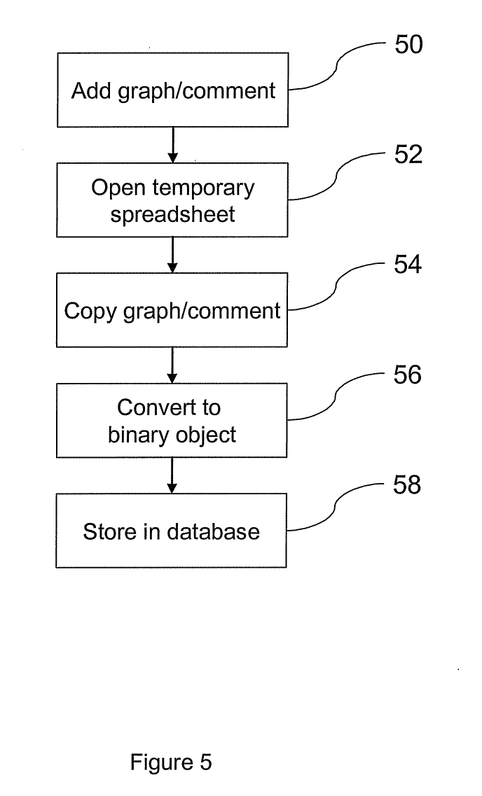

FIG. 5 shows the control flow executed when writing a report definition element such as a graph or text box to the definition database. After the element has been created 50 within a spreadsheet, a second, temporary spreadsheet is opened 52, and the element is copied 54 into this temporary spreadsheet. The temporary sheet is then converted 56 into a binary long object, which is stored 58 in the report definition database as an OLE object type.

Although not explicitly shown, there may be many other computer terminals connected to the report definition and source data databases to allow multiple simultaneous user access. The Access database used to store and manage the report definitions is clearly well adapted for this. As new report definitions and report definition elements are created and uploaded into the Access database they become available for use by other users.

1. A method of preparing customised reports from source data comprising:
retrieving a report definition from a first database;
loading the retrieved report definition into a report-generating means, wherein the report-generating means is independent of said first database;
retrieving source data from a second database into said report-generating means as specified by said report definition; and
performing operations on said retrieved source data to produce a report in accordance with the report definition.

2. A method as claimed in claim 1 wherein the first database comprises a relational database.

3. A method as claimed in claim 1 wherein the first database comprises information relating to the hierarchy of the data structures of the second database.

4. A method as claimed in claim 1 wherein the second database comprises a multidimensional database.

5. A method as claimed in claim 1 wherein the report definitions are stored in the first database as binary long objects.

6. A method as claimed in claim 1 wherein the report-generating means is a spreadsheet application and the report definitions comprise spreadsheet files.

7. A method as claimed in claim 1 wherein the report-generating means comprises a spreadsheet containing Visual Basic code.

8. A method as claimed in claim 1 comprising the steps of creating a blank spreadsheet, retrieving a report definition spreadsheet from the first database and copying data from the report definition spreadsheet to said blank spreadsheet.

9. A method as claimed in claim 1 comprising the step of the report-generating means creating a new report definition and/or modifying an existing definition.

10. A method as claimed in claim 1 wherein said source data is financial data.

11. A method as claimed in claim 1 wherein the second database comprises a financial consolidation package.

12. Apparatus for preparing customised reports from source data comprising:
a first database containing a plurality of report definitions;
a report-generating means independent of said first database; and
a second database comprising source data,
wherein said apparatus is arranged to:
retrieve a report definition from said first database;
retrieve source data from said second database; and
perform operations on said retrieved source data to produce a report in accordance with said report definition.

13. Apparatus as claimed in claim 12 in which the report-generating means is independent of the said second database.

14. Apparatus as claimed in claim 12 in which the first database and the second database are linked to enable sharing or user authentication.

15. Apparatus as claimed in claim 12 wherein the first database comprises a relational database.

16. Apparatus as claimed in claim 12 wherein the first database comprises information relating to the hierarchy of the data structures of the second database.

17. Apparatus as claimed in claim 12 wherein the second database comprises a multidimensional database.

18. Apparatus as claimed in claim 12 wherein the report definitions are stored in the first database as Binary Long Objects.

19. Apparatus as claimed in claim 12 wherein the report-generating means is a spreadsheet application and the report definitions comprise spreadsheet files.

20. Apparatus as claimed in claim 12 wherein the report-generating means comprises a spreadsheet containing Visual Basic code.

21. Apparatus as claimed in claim 12 wherein the report-generating means is arranged to create a blank spreadsheet, retrieve a report definition spreadsheet from the first database and copy data from the report definition spreadsheet to said blank spreadsheet.

22. Apparatus as claimed in claim 12 wherein the report-generating means is adapted to allow the creation of a new report definition and/or the modification of an existing definition.

23. Apparatus as claimed in claim 12 wherein said source data is financial data.

24. A method as claimed in claim 12 wherein the second database comprises a financial consolidation package.

25. Computing apparatus having means for generating a report, said report-generating means being arranged to communicate with a first database server having a database containing report definitions to retrieve a report definition therefrom; and also being arranged to communicate with a second database containing source data for retrieving said source data therefrom, the report-generating means further being arranged to perform operations on said retrieved source data to produce a report in accordance with the report definition.

26. A relational database comprising a plurality of binary objects corresponding to report definitions for a spreadsheet application.

27. A relational database as claimed in claim 26 in which the binary objects are stored as binary long objects.

28. A relational database as claimed in claim 26 in which the binary objects are stored as OLE objects.

29. A computer software product which when run on a computing means causes it to:
retrieve a report definition from a first database;
load the retrieved report definition into a report-generating means, wherein the report-generating means is independent of said first database;
retrieve source data from a second database into said report-generating means as specified by said report definition; and
perform operations on said retrieved source data to produce a report in accordance with the report definition.

30. Software and/or a software product for generating a report comprising:
logic for retrieving a report definition from a first independent database, said report definition a source data specification;
logic for retrieving source data from a second independent database as specified in said source data specification; and
logic for performing operations on said source data to produce a report in accordance with said report definition.

31. A data carrier carrying software as claimed in claim 30.
